(19) United States
(12) Patent Application Publication
(10) Pub. No.: US 2025/0292273 A1
(43) Pub. Date: Sep. 18, 2025

(54) SYSTEM AND METHOD TO CREATE INTERACTIVE PERSONAS FOR DESIGN

(71) Applicant: TOYOTA RESEARCH INSTITUTE, INC., Los Altos, CA (US)

(72) Inventors: Matthew KLENK, San Francisco, CA (US); Ryosuke NAKANISHI, San Jose, CA (US); Shabnam HAKIMI, San Francisco, CA (US); Yin-Ying YANG, San Jose, CA (US); Pablo PAREDES CASTRO, San Leandro, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/607,388

(22) Filed: Mar. 15, 2024

(51) Int. Cl. G06Q 30/0203

(52) U.S. Cl. CPC G06Q 30/0203

(57) ABSTRACT

A method for generating an interactive persona design system is described. The method includes creating a persona description, by a designer/marketer, representing a synthetic person for which an interview is desired regarding a survey of new questions. The method also includes translating, using a personalization model, the persona description into a personalization vector, in which the personalization vector represents the synthetic person. The method further includes creating a query vector including an individual task model for each question of the survey of new questions. The method also includes training a choice model based on the personalization vector and the individual task models for each survey question of the query vector to predict a response of the synthetic persona for each of the survey of new questions based on the persona description.

### BACKGROUND

### Field

Certain aspects of the present disclosure generally relate to machine assisted design and, more particularly, to a system and method for creating interactive personas for design.

### Background

As described, personas are fictional characters, which are created based upon research in order to represent the different user types that might use a service, product, site, or brand in a similar way. Current state-of-the-art in persona generation includes computational agents powered by large language models (LLMs) that can be used as synthetic participants or observed as agent-based models to understand aggregate behavior. Creating personas helps a designer to understand users' needs, experiences, behaviors, and goals.

The current state-of-the-art in persona generation, however, does not provide a new mechanism to understand and explore the implications of the noted behaviors. Additionally, LLM-based systems are prone to amplify the bias in their datasets and are unable to connect their responses to actual data. An approach that leverages previous studies run by an organization to create a multi-task learned representation for (1) a personalization vector, and (2) individual task models for each survey question, is desired.

### SUMMARY

A method for generating an interactive persona design system is described. The method includes creating a persona description, by a designer/marketer, representing a synthetic person for which an interview is desired regarding a survey of new questions. The method also includes translating, using a personalization model, the persona description into a personalization vector, in which the personalization vector represents the synthetic person. The method further includes creating a query vector including an individual task model for each question of the survey of new questions. The method also includes training a choice model based on the personalization vector and the individual task models for each survey question of the query vector to predict a response of the synthetic persona for each of the survey of new questions based on the persona description.

A non-transitory computer-readable medium having program code recorded thereon for generating an interactive persona design system is described. The program code is executed by a processor. The non-transitory computer-readable medium includes program code to create a persona description, by a designer/marketer, representing a synthetic person for which an interview is desired regarding a survey of new questions. The non-transitory computer-readable medium also includes program code to translate, using a personalization model, the persona description into a personalization vector, in which the personalization vector represents the synthetic person. The non-transitory computer-readable medium further includes program code to create a query vector including an individual task model for each question of the survey of new questions. The non-transitory computer-readable medium also includes program code to train a choice model based on the personalization vector and the individual task models for each survey question of the query vector to predict a response of the synthetic persona for each of the survey of new questions based on the persona description.

An interactive persona design system is described. The system includes a previous consumer survey analysis module to create a persona description, by a designer/marketer, representing a synthetic person for which an interview is desired regarding a survey of new questions. The system also includes a multi-task learned representation module to translate, using a personalization model, the persona description into a personalization vector, in which the personalization vector represents the synthetic person. The system further includes a persona description module to create a query vector including an individual task model for each question of the survey of new questions. The system also includes multi-task learned representation training module to train a choice model based on the personalization vector and the individual task models for each survey question of the query vector to predict a response of the synthetic persona for each of the survey of new questions based on the persona description.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of an interactive persona design system, in accordance with aspects of the present disclosure.

FIG. 2 is a block diagram illustrating an exemplary software architecture that may modularize artificial intelligence (AI) functions for an interactive persona design system, according to aspects of the present disclosure.

FIG. 3 is a diagram illustrating a hardware implementation for an interactive persona design system, according to aspects of the present disclosure.

FIG. 4 is a block diagram illustrating an interactive persona design system, according to various aspects of the present disclosure.

FIG. 5 is a process flow diagram illustrating a method for an interactive persona design system, according to various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

As described, personas are fictional characters, which are created based upon research in order to represent the different user types that might use a service, product, site, or brand in a similar way. Current state-of-the-art in persona generation includes computational agents powered by large language models (LLMs) that can be used as synthetic participants or observed as agent-based models to understand aggregate behavior. Creating personas helps a designer to understand users' needs, experiences, behaviors, and goals.

The current state-of-the-art in persona generation, however, does not provide a new mechanism to understand and explore the implications of the noted behaviors. Additionally, LLM-based systems are prone to amplify the bias in their datasets and are unable to connect their responses to actual data. An approach that leverages previous studies run by an organization to create a multi-task learned representation for (1) a personalization vector, and (2) individual task models for each survey question, is desired.

Aspects of the present disclosure go beyond conventional systems by providing a new mechanism to understand and explore the implications of understanding aggregate behaviors. Various aspects of the present disclosure leverage previous studies run by an organization to create a multi-task learned representation for (1) a personalization vector, and (2) individual task models for each survey question. Beneficially, the answers to any new question can be explored by a user in terms of personalization vectors and corresponding survey questions that support a synthetic response.

Various aspects of the present disclosure allow for generation of highly targeted segments (e.g., a persona that is both high in openness and makes impatient choices in economic decision-making tasks). Additionally, an interactive persona design system may also pilot a survey to test out the feedback from a synthesized population to determine important parameters before rolling the survey out to real human participants. Some aspects of the present disclosure help designers envision how customers will respond to new products. Instead of fielding new studies, companies can leverage previous studies to automatically answer new questions.

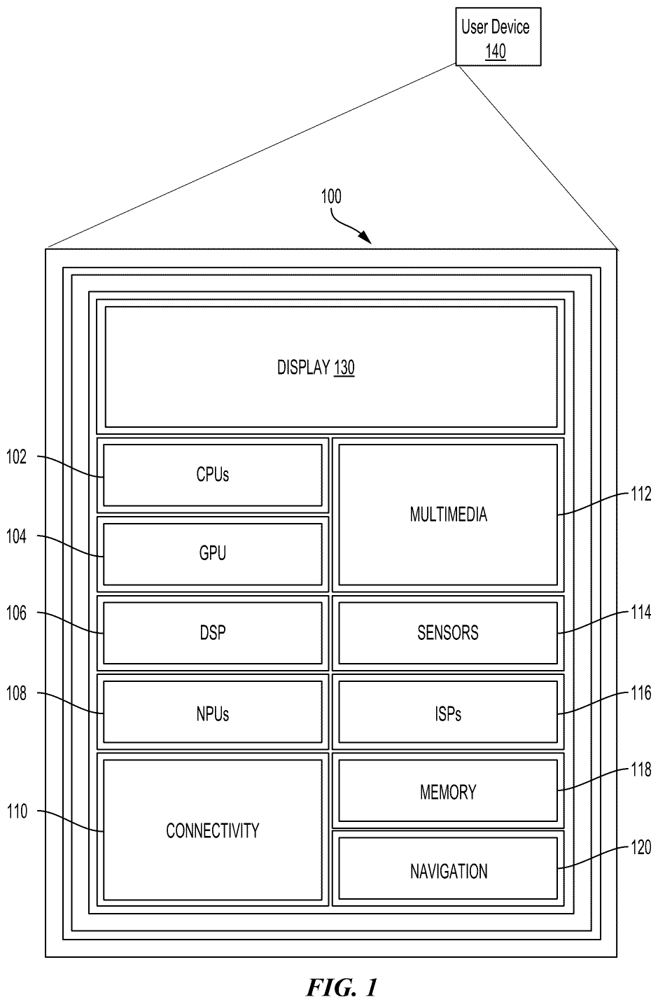

FIG. 1 illustrates an example implementation of the aforementioned system and method for an interactive persona design system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., the CPU 102) or the NPU 108 may include code to provide an interactive persona design system for creating a multi-task learned representation of (1) a personalization vector, and (2) individual task models for each survey question. The instructions loaded into a processor (e.g., the NPU 108) may also include code to leverage previous consumer discrete choice surveys and/or previous consumer survey responses to provide synthetic data participants to answer a survey of new questions. The instructions loaded into the processor (e.g., the NPU 108) may also include code to create a multi-task learned representation for a personalization vector and individual task models for each survey question. The instructions loaded into the processor (e.g., the NPU 108) may also include code to create a persona description, by a designer or marketer, representing a person for which an interview is desired. The instructions loaded into the processor (e.g., the NPU 108) may also include code to train the multi-task learned representation for the personalization vector and individual task models for each survey question to predict a response of the persona description for each survey question.

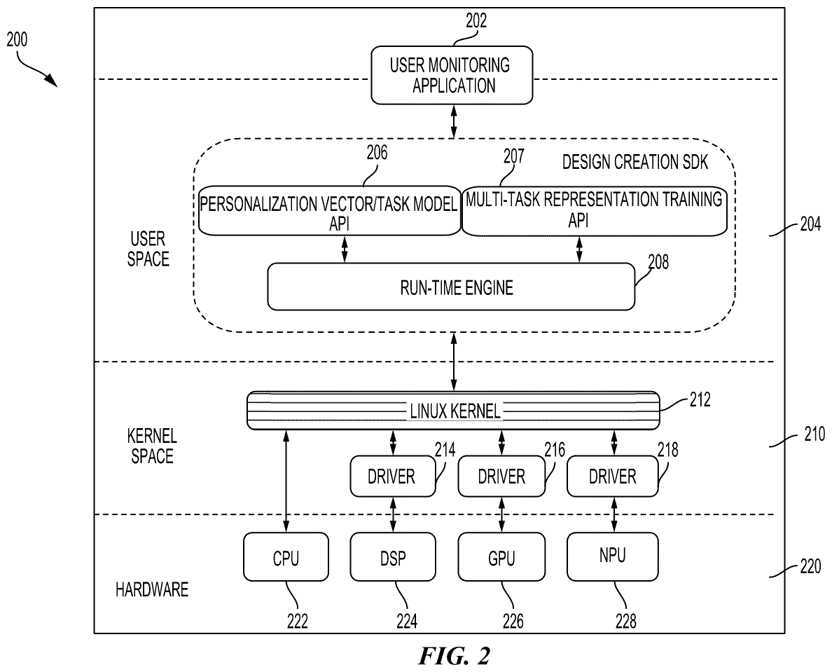

FIG. 2 is a block diagram illustrating a software architecture 200 that may modularize artificial intelligence (AI) functions for an interactive persona design system, according to aspects of the present disclosure. Using the architecture, a user monitoring application 202 may be designed such that it may cause various processing blocks of an SOC 220 (for example a CPU 222, a DSP 224, a GPU 226, and/or an NPU 228) to perform supporting computations during run-time operation of the user monitoring application 202. FIG. 2 describes the software architecture 200 for an interactive persona design system. It should be recognized that the interactive persona design system is not limited to any specific information. According to aspects of the present disclosure, the user monitoring and the interactive persona design functionality is applicable to any type of information survey prediction activity.

The user monitoring application 202 may be configured to call functions defined in a user space 204 that may, for example, provide interactive persona design services. The user monitoring application 202 may make a request for compiled program code associated with a library defined in a personalization vector/task model application programming interface (API) 206. The personalization vector/task model API 206 is configured to leverage previous consumer discrete choice surveys and/or previous consumer survey responses to provide synthetic data participants to answer a survey of new questions. The personalization vector/task model API 206 is further configured to create a multi-task learned representation for a personalization vector and individual task models for each survey question.

In response, compiled program code of a multi-task representation training API 207 is configured to create a persona description, by a designer or marketer, representing a person for which an interview is desired. Additionally, the multi-task representation training API 207 is configured to train the multi-task learned representation for the personalization vector and individual task models for each survey question to predict a response of the persona description for each survey question.

A run-time engine 208, which may be compiled code of a run-time framework, may be further accessible to the user monitoring application 202. The user monitoring application 202 may cause the run-time engine 208, for example, to take actions for predicting a response of the persona description for each survey question. In response to recommendation of visual content, the run-time engine 208 may in turn send a signal to an operating system 210, such as a Linux Kernel 212, running on the SOC 220. FIG. 2 illustrates the Linux Kernel 212 as software architecture for an interactive persona design system. It should be recognized, however, that aspects of the present disclosure are not limited to this exemplary software architecture. For example, other kernels may provide the software architecture to support the interactive persona design functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

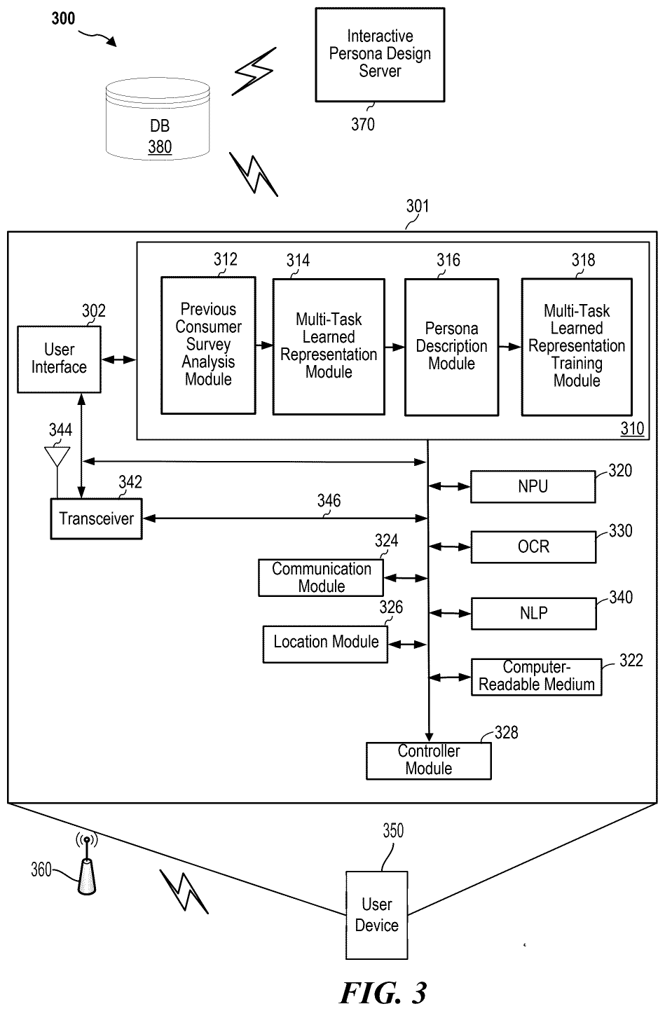

As noted above, personas are fictional characters created based upon research in order to represent different user types that might use a service, product, site, or brand in a similar way. Current state-of-the-art in persona generation includes computational agents powered by large language models (LLMs) that can be used as synthetic participants or observed as agent-based models to understand aggregate behavior. Creating personas helps a designer to understand users' needs, experiences, behaviors and goals. The current state-of-the-art in persona generation, however, does not provide a new mechanism to understand and explore the implications of the noted behaviors. Additionally, LLM-based systems are prone to amplify the bias in their datasets and are unable to connect their responses to actual data. Various aspects of the present disclosure leverage previous studies run by an organization to create a multi-task learned representation for (1) a personalization vector, and (2) individual task models for each survey question, for example, as shown in FIG. 3.

FIG. 3 is a diagram illustrating a hardware implementation for an interactive persona design system 300, according to aspects of the present disclosure. The interactive persona design system 300 may be configured to leverage previous studies run by an organization to create a multi-task learned representation for (1) a personalization vector, and (2) individual task models for each survey question. The interactive persona design system 300 then trains the multi-task learned representation for the personalization vector and individual task models for each survey question to predict a response of the persona description for each survey question.

The interactive persona design system 300 includes a user monitoring system 301 and an interactive persona design server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The interactive persona design server 370 may connect to the user device 350 for helping designers envision how customers will respond to new products. For example, instead of fielding new studies, companies can leverage previous studies stored by the interactive persona design server 370 to automatically answer new questions. In various aspects of the present disclosure, the interactive persona design server 370 leverages the previous studies run by the organization to create a multi-task learned representation for (1) a personalization vector, and (2) individual task models for each survey question. Therefore, the answers to any new question can be explored by the user in terms of personalization vector and the survey questions that support the synthetic response. This structure also allows the interactive persona design server 370 to generate highly targeted segments (e.g., a persona that is both high in openness and makes impatient choices in economic decision-making tasks). Additionally, the interactive persona design server 370 pilots a survey to test out the feedback from a synthesized population to determine important parameters before rolling the survey out to real human participants.

The user monitoring system 301 may be implemented with an interconnected architecture, represented by an interconnect 346, which may be implemented as a controller area network (CAN). The interconnect 346 may include any number of point-to-point interconnects, buses, and/or bridges depending on the specific application of the user monitoring system 301 and the overall interactive persona design constraints. The interconnect 346 links together various circuits including one or more processors and/or hardware modules, represented by a user interface 302, a user activity module 310, a neural network processor (NPU) 320, a computer-readable medium 322, a communication module 324, a location module 326, a controller module 328, an optical character recognition (OCR) 330, and a natural language processor (NLP) 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the controller module 328, the OCR 330, and NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the user activity module 310 to/from connected devices within the vicinity of the user device 350.

The user monitoring system 301 includes the NPU 320, the OCR 330, and the NLP 340 coupled to the computer-readable medium 322. The NPU 320, the OCR 330, and NLP 340 performs processing, including the execution of software stored on the computer-readable medium 322 to provide a neural network model for user monitoring and statistical data clarification functionality according to the present disclosure. The software, when executed by the NPU 320, the OCR 330 and the NLP 340, causes the user monitoring system 301 to perform the various functions described for interactive persona designs presented to the user through the user device 350, or any of the modules (e.g., 310, 324, 326, and/or 328). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the OCR 330 and the NLP 340 to automatically detect multiple objects in an image displayed on the user's workspace. The user monitoring system 301 may follow a process to detect and determine whether the user accesses creative content. When the user curates images, the user monitoring system 301 utilizes the OCR 330 and/or the NLP 340 to analyze designs of detected objects in the image displayed on the user's workspace.

The user activity module 310 may be in communication with the user interface 302, the NPU 320, the computer-readable medium 322, the communication module 324, the location module 326, the controller module 328, the OCR 330, the NLP 340, and the transceiver 342. In one configuration, the user activity module 310 monitors communications from the user interface 302. The user interface 302 may monitor user communications to and from the communication module 324. According to aspects of the present disclosure, the OCR 330 and the NLP 340 automatically detect images displayed on the user's workspace and may use computer vision object detection and instance segmentation techniques.

As shown in FIG. 3, the user activity module 310 includes a previous consumer survey analysis module 312, a multi-task learned representation module 314, a persona description module 316, and a multi-task learned representation training module 318. The previous consumer survey analysis module 312, the multi-task learned representation module 314, the persona description module 316, and the multi-task learned representation training module 318 may be components of a same or different artificial neural network, such as a deep convolutional neural network (CNN). The user activity module 310 is not limited to a CNN. The user activity module 310 helps designers envision how customers will respond to new products by providing a persona description through the user interface 302.

This configuration of the user activity module 310 includes the previous consumer survey analysis module 312 configured to leverage previous consumer discrete choice surveys and/or previous consumer survey responses to provide synthetic data participants to answer a survey of new questions. For example, instead of fielding new studies, companies can leverage previous studies to automatically answer new questions. These previous studies may be stored by the interactive persona design server 370.

In various aspects of the present disclosure, the user activity module 310 includes the multi-task learned representation module 314 configured to create a multi-task learned representation for a personalization vector and individual task models for each survey question. The multi-task learned representation module 314 enables user exploration of the answers to any new question in terms of a personalization vector and the survey questions that support a synthetic response. This structure also allows multi-task learned representation module 314 to generate highly targeted segments (e.g., a persona that is both high in openness and makes impatient choices in economic decision-making tasks).

In this example, the user activity module 310 also includes the persona description module 316 configured to create a persona description, by a designer or marketer, representing a person for which an interview is desired. Additionally, the persona description module 316 enables piloting of a survey to test out the feedback from a synthesized population to determine important parameters before rolling the survey out to real human participants.

As further shown in FIG. 3, the user activity module 310 includes the multi-task learned representation training module 318 configured to train the multi-task learned representation for the personalization vector and individual task models for each survey question to predict a response of the persona description for each survey question. Thus, aspects of the present disclosure create detailed behavioral models of each survey question and a personalization vector within a natural workflow.

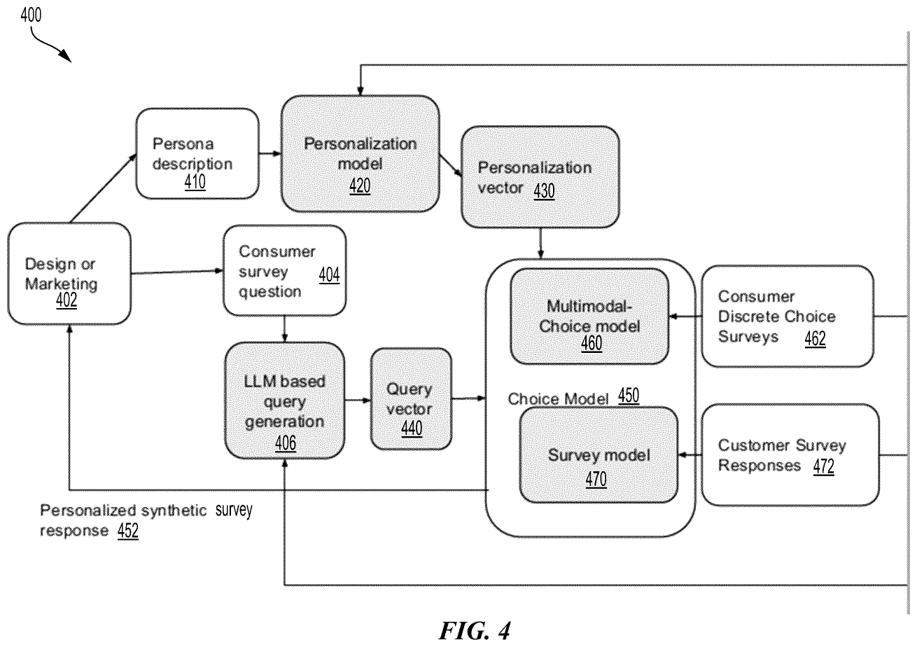

In some aspects of the present disclosure, the user activity module 310 may be implemented and/or work in conjunction with the interactive persona design server 370. In one configuration, a database (DB) 380 stores data related to previous studies of a company, which may be displayed as output through the user interface 302. In some aspects of the present disclosure, the interactive persona design system 300 may be implemented as a web browser plugin. In other aspects of the present disclosure, the interactive persona design server 370 provides an offline application that scans content viewed through the user interface 302. In other aspects of the present disclosure, the interactive persona design system 300 may be implemented as a mobile application that connects the question to a closest individual choice model and then uses the personalization vector to query those models and aggregates the answers into a personalized synthetic survey response, for example, as shown in FIG. 4.

FIG. 4 is a block diagram illustrating an interactive persona design system, according to various aspects of the present disclosure. As shown in FIG. 4, the interactive persona design system 400 begins with a design/marketing 402 for which a designer desires assistance with envisioning how customers will respond to new products or determine a public opinion. According to various aspects of the present disclosure, rather than fielding new studies, companies can leverage previous studies to automatically answer a new consumer survey question 404.

In this example, a designer/marketer first creates a persona description 410 that represents the person the designer/marketer desires to interview. The persona description 410 may be a natural language and/or a collection of visuals. In various aspects of the present disclosure, the persona description 410 is translated into a personalization vector 430 using a machine learning personalization model 420, in which the personalization vector 430 represents a synthetic person the designer/marketer desires to interview. In this example, the contents of the personalization vector 430 are an embedding, generated by a multi-task learning process with existing consumer research datasets.

As further illustrated in FIG. 4, the designer/marketer creates their consumer survey question 404 and feeds the consumer survey question 404 to a query generation system 406 (e.g., a large language model (LLM)-based query generation system). In various aspects of the present disclosure, the query generation system 406 is also fed the consumer discrete choice surveys 462 and consumer survey responses 472 to enable generation of a query vector 440. In various aspects of the present disclosure, the query vector 440 connects the consumer survey question 404 to the closest individual one of the choice model 450. According to various aspects of the present disclosure, the choice model 450 uses the query vector 440 and then the personalization vector 430 to query a multimodal-choice model 460 and a survey model 470 and aggregates the answers in a personalized synthetic survey response 452. In this example, the multimodal-choice model 460 is based on the consumer discrete choice surveys 462, and the survey model 470 is based on the consumer survey responses 472.

According to various aspects of the present disclosure, the consumer survey question 404 may include multiple choice, free response, and multi-media choice surveys. By modifying the persona description 410, the designer/marketer can then see how that impacts the personalized synthetic survey response 452 to the consumer survey question 404. Furthermore, the designer/marketer can also see the data that is being used to generate the personalized synthetic survey response 452. Various aspects of the present disclosure enable leveraging previous consumer discrete choice surveys 462 and/or previous consumer survey responses 472 to provide synthetic data participants to answer a survey of new questions, through the personalized synthetic survey response 452.

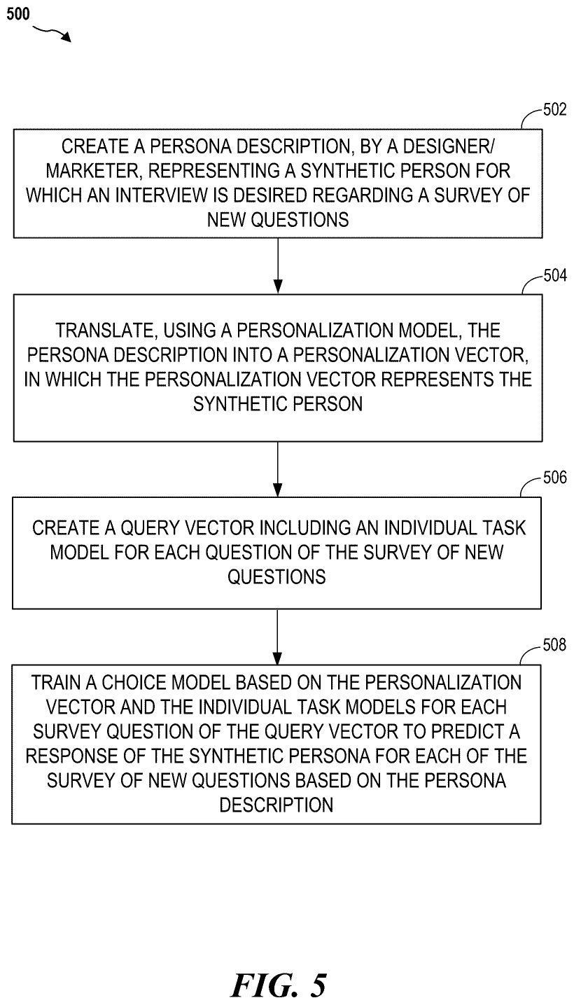

Additionally, the designer/marketer may also test the extent to which the specific persona parametrization affects the personalized synthetic survey response 452, effectively answering the question, “at what point does a specific persona matter for a given response?” And the extent of impact from persona parameterization can also be used to calibrate the design of the consumer survey question 404. For example, if the personalized synthetic survey response 452 for the consumer survey question 404 is too subjective or over biased toward a prior survey question, the interactive persona design system 400 can suggest the survey designer revise the questions or change the order of questions in the consumer survey question 404. The process for the interactive persona design system 400 is illustrated, for example, in FIG. 5.

FIG. 5 is a process flow diagram illustrating a method 500 for an interactive persona design system, according to various aspects of the present disclosure. The method 500 begins at block 502, in which a persona description is created by a designer/marketer, in which the persona description represents a synthetic person for which an interview is desired regarding a survey of new questions. For example, As shown in FIG. 4, the interactive persona design system 400 begins with the design/marketing 402 for which a designer desires assistance with envisioning how customers will respond to new products or determine a public opinion. According to various aspects of the present disclosure, rather than fielding new studies, companies can leverage previous studies to automatically answer a new consumer survey question 404.

At block 504, the persona description is translated into a personalization vector using a personalization model, in which the personalization vector represents the synthetic person. For example, as shown in FIG. 4, the persona description 410 is translated into a personalization vector 430 using a machine learning personalization model 420, in which the personalization vector 430 represents a synthetic person the designer/marketer desires to interview. In this example, the contents of the personalization vector 430 are an embedding, generated by a multi-task learning process with existing consumer research datasets.

At block 506, a query vector is created, including an individual task model for each question of the survey of new questions. For example, as shown in FIG. 4, the query generation system 406 is fed the consumer discrete choice surveys 462 and consumer survey responses 472 to enable generation of a query vector 440. In various aspects of the present disclosure, the query vector 440 connects the consumer survey question 404 to the closest individual one of the choice model 450.

At block 508, a choice model is trained based on the personalization vector and the individual task models for each survey question of the query vector to predict a response of the synthetic persona for each of the survey of new questions based on the persona description. In various aspects of the present disclosure, the query vector 440 connects the consumer survey question 404 to the closest individual one of the choice model 450. According to various aspects of the present disclosure, the choice model 450 is trained using the query vector 440 and then the personalization vector 430 to query a multimodal-choice model 460 and a survey model 470 and aggregates the answers in a personalized synthetic survey response 452. In this example, the multimodal-choice model 460 is based on the consumer discrete choice surveys 462, and the survey model 470 is based on the consumer survey responses 472.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in several ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for generating an interactive persona design system, the method comprising:
creating a persona description, by a designer/marketer, representing a synthetic person for which an interview is desired regarding a survey of new questions;
translating, using a personalization model, the persona description into a personalization vector, in which the personalization vector represents the synthetic person;
creating a query vector including an individual task model for each question of the survey of new questions; and
training a choice model based on the personalization vector and the individual task models for each survey question of the query vector to predict a response of the synthetic persona for each of the survey of new questions based on the persona description.

2. The method of claim 1, further comprising leveraging previous consumer discrete choice surveys and/or previous consumer survey responses to provide synthetic data participants to answer the survey of new questions.

3. The method of claim 1, further comprising tuning the personalization vector and the individual task models of the query vector for each of the questions of the survey of new questions to add/remove data points.

4. The method of claim 1, in which the persona description comprises a natural language and/or a collection of visuals.

5. The method of claim 1, further displaying the response of the synthetic persona for each of the survey of new questions.

6. The method of claim 1, in which contents of the personalization vector comprise an embedding, generated by a multi-task learning process using existing consumer research datasets.

7. The method of claim 1, further comprising feeding a large language model (LLM)-based query generation system consumer discrete choice surveys and customer survey responses enable generation the query vector, in which the query vector connects each consumer survey question to the choice model.

8. The method of claim 1, further comprising modifying the persona description to detect an impact on a personalized synthetic survey response to each of the questions of the survey of new questions.

9. A non-transitory computer-readable medium having program code recorded thereon for generating an interactive persona design system, the program code being executed by a processor and comprising:
program code to create a persona description, by a designer/marketer, representing a synthetic person for which an interview is desired regarding a survey of new questions;
program code to translate, using a personalization model, the persona description into a personalization vector, in which the personalization vector represents the synthetic person;
program code to create a query vector including an individual task model for each question of the survey of new questions; and
program code to train a choice model based on the personalization vector and the individual task models for each survey question of the query vector to predict a response of the synthetic persona for each of the survey of new questions based on the persona description.

10. The non-transitory computer-readable medium of claim 9, further comprising program code to leverage previous consumer discrete choice surveys and/or previous consumer survey responses to provide synthetic data participants to answer the survey of new questions.

11. The non-transitory computer-readable medium of claim 9, further comprising program code to tune the personalization vector and the individual task models of the query vector for each of the survey of new questions to add/remove data points.

12. The non-transitory computer-readable medium of claim 9, in which the persona description comprises a natural language and/or a collection of visuals.

13. The non-transitory computer-readable medium of claim 9, further comprising program code to display the response of the synthetic persona for each of the survey of new questions.

14. The non-transitory computer-readable medium of claim 9, in which contents of the personalization vector comprise an embedding, generated by a multi-task learning process using existing consumer research datasets.

15. The non-transitory computer-readable medium of claim 9, further comprising program code to feed a large language model (LLM)-based query generation system consumer discrete choice surveys and customer survey responses enable generation the query vector, in which the query vector connects each consumer survey question to the choice model.

16. The non-transitory computer-readable medium of claim 9, further comprising program code to modify the persona description to detect an impact on a personalized synthetic survey response to each of the questions of the survey of new questions.

17. An interactive persona design system, the system comprising:
a previous consumer survey analysis module to create a persona description, by a designer/marketer, representing a synthetic person for which an interview is desired regarding a survey of new questions;
a multi-task learned representation module to translate, using a personalization model, the persona description into a personalization vector, in which the personalization vector represents the synthetic person;
a persona description module to create a query vector including an individual task model for each question of the survey of new questions; and
multi-task learned representation training module to train a choice model based on the personalization vector and the individual task models for each survey question of the query vector to predict a response of the synthetic persona for each of the survey of new questions based on the persona description.

18. The system of claim 17, in which the previous consumer survey analysis module is further to leverage previous consumer discrete choice surveys and/or previous consumer survey responses to provide synthetic data participants to answer the survey of new questions.

19. The system of claim 17, further comprising a display to display the response of the synthetic persona for each of the survey of new questions.

20. The system of claim 17, in which the multi-task learned representation module is further to modify the persona description to detect an impact on a personalized synthetic survey response to each of the questions of the survey of new questions.
